(19) United States
(12) Patent Application Publication
(10) Pub. No.: US 2024/0429660 A1
(43) Pub. Date: Dec. 26, 2024

(54) Plug Connector For Making Contact With a Printed Circuit Board

(71) Applicant: ERNI International AG, Schaffhausen (CH)

(72) Inventors: Stefan Molitor, Waschenbeuren (DE); Stephen Kaminski, Salach (DE)

(73) Assignee: ERNI International AG, Schaffhausen (CH)

(21) Appl. No.: 18/804,413

(22) Filed: Aug. 14, 2024

Related U.S. Application Data
(63) Continuation of application No. PCT/EP2023/053230, filed on Feb. 9, 2023.

(30) Foreign Application Priority Data
Feb. 14, 2022 (DE) 10 2022 103 411.9

(51) Int. Cl. H01R 13/6594; H01R 12/70

(52) U.S. Cl. CPC H01R 13/6594; H01R 12/707

(57) ABSTRACT

A plug connector includes a plug connector housing having a fastening mechanism and a shielding plate or a retaining plate connected to the fastening mechanism. The shielding plate is fastenable to a plurality of solder points of a printed circuit board and the plug connector is fastened to the printed circuit board by the shielding plate and the fastening mechanism. The retaining plate is connected to the fastening mechanism with the shielding plate omitted. The retaining plate has a height that is less than a height of the plug connector housing. The retaining plate is fastenable to the plurality of solder points of the printed circuit board and the plug connector is fastened to the printed circuit board by the retaining plate and the fastening mechanism.

### CROSS-REFERENCE TO RELATED APPLICATIONS

This application is a continuation of PCT International Application No. PCT/EP2023/053230, filed on Feb. 9, 2023, which claims priority under 35 U.S.C. § 119 to German Patent Application No. 102022103411.9, filed on Feb. 14, 2022.

### FIELD OF THE INVENTION

The present invention relates to a plug connector for making contact with a printed circuit board, which can be fastened to the printed circuit board via solder points.

### BACKGROUND OF THE INVENTION

Plug connectors are used to contact printed circuit boards. In this context, plug connectors are fastened to the printed circuit board by soldering and electrically contacted. The plug connectors have a housing and several contact elements arranged in it. A component to be connected to the printed circuit board has a mating plug connector that is plugged into the plug connector on the printed circuit board. The plug connector and/or the mating connector can be shielded by providing a shielding plate on the housing; they can also be unshielded.

In addition to shielding, the shielding plate can also be used to connect the connector to the printed circuit board. For this purpose, a fastening mechanism is provided on the plug connector, via which the shielding plate can be connected to the plug connector. To fasten the shielding plate to the printed circuit board, a section of the shielding plate is soldered to the solder points on the printed circuit board provided for this purpose, creating a materially bonded and electrically conductive connection that is robust against external influences. As a result, the plug connector is fastened to the printed circuit board by the shielding plate and the fastening mechanism.

EP 12 51 591 A2 discloses such a plug connector, which is particularly suitable for SMD (surface mounted device) plug connections. The shielding plates are connected to the plug connector element via latching connections and have solder lugs, which are used to make electrical contact with the shielding plates and with which the shielding plate and consequently also the plug connector element are fastened to a printed circuit board.

In U.S. Pat. No. 6,080,016, a device for connecting printed circuit boards is disclosed. A connection socket has a housing, on the side surfaces of which a metallic shielding is mounted. The metallic shielding has solder pads which are fastened to a printed circuit board by soldering. In addition, a connector has further solder pads arranged at the lateral ends of its housing. The solder pads of the connector are soldered to the other printed circuit board. In the mated state of the plug connector, the solder pads of the connector are connected to a foot of the shielding plate of the connection socket.

Unshielded plug connectors are typically anchored to the printed circuit board via strain relief brackets. These strain relief brackets are connected to the printed circuit board via separate solder points. There is a need for a simple fastening of unshielded and shielded plug connectors on printed circuit boards with the same arrangement (layout) of solder points.

### SUMMARY OF THE INVENTION

A plug connector includes a plug connector housing having a fastening mechanism and a shielding plate or a retaining plate connected to the fastening mechanism. The shielding plate is fastenable to a plurality of solder points of a printed circuit board and the plug connector is fastened to the printed circuit board by the shielding plate and the fastening mechanism. The retaining plate is connected to the fastening mechanism with the shielding plate omitted. The retaining plate has a height that is less than a height of the plug connector housing. The retaining plate is fastenable to the plurality of solder points of the printed circuit board and the plug connector is fastened to the printed circuit board by the retaining plate and the fastening mechanism.

### BRIEF DESCRIPTION OF THE DRAWINGS

Embodiments of the invention are shown in the drawings and explained in more detail in the following description, wherein:

FIG. 1 shows an isometric view of a printed circuit board;

FIG. 2 shows an isometric view of a first embodiment of a plug connector according to the invention with a shielding plate viewed from the front;

FIG. 3 shows an isometric view of the first embodiment of the plug connector with a retaining plate viewed from the front;

FIG. 4 shows an isometric view of the first embodiment of the plug connector with the shielding plate viewed from above;

FIG. 5 shows an isometric view of the first embodiment of the plug connector with the retaining plate viewed from above;

FIG. 6 shows a sectional view of the plug connector according to the first embodiment with the shielding plate;

FIG. 7 shows a sectional view of the plug connector of the first embodiment with the retaining plate;

FIG. 8 shows an isometric view of the first embodiment of the plug connector with the retaining plate and a mating plug connector with a retaining plate, which are plugged into one another;

FIG. 9 shows an isometric view of a second embodiment of a plug connector according to the invention with a shielding plate viewed from the front;

FIG. 10 shows an isometric view of the second embodiment of the plug connector with a retaining plate viewed from the front;

FIG. 11 shows an isometric view of the second embodiment of the plug connector with a shielding plate viewed from the rear; and

FIG. 12 shows an isometric view of the second embodiment of the plug connector with a retaining plate viewed from the rear.

### DETAILED DESCRIPTION

The accompanying drawings are incorporated into the specification and form a part of the specification to illustrate several embodiments of the present invention. These drawings, together with the description, explain the principles of the invention. The drawings are merely for the purpose of illustrating examples of how the invention can be made and used and are not to be construed as limiting the invention to only the illustrated and described embodiments. Furthermore, several aspects of the embodiments may form—individually or in different combinations—solutions according to the present invention. The following described embodiments thus can be considered either alone or in an arbitrary combination thereof. In the drawings, only one reference sign is shown for an exemplary element in the case of several identical elements, in order to provide a better overview.

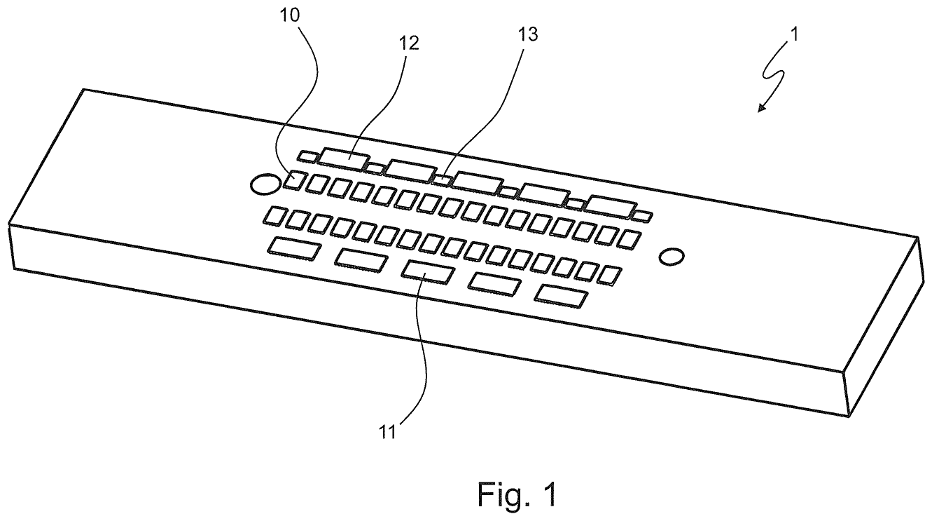

FIG. 1 shows a printed circuit board 1 with a predetermined arrangement (layout) of solder points 10, 11, 12, 13, which is adapted to an embodiment of the plug connector 2 according to the invention (see further Figures). First solder points 10 are contacted on or within the printed circuit board 1 for data transfer. Second solder points 11, third solder points 12 and possibly fourth solder points 13 are contacted in such a way that shielding can be provided.

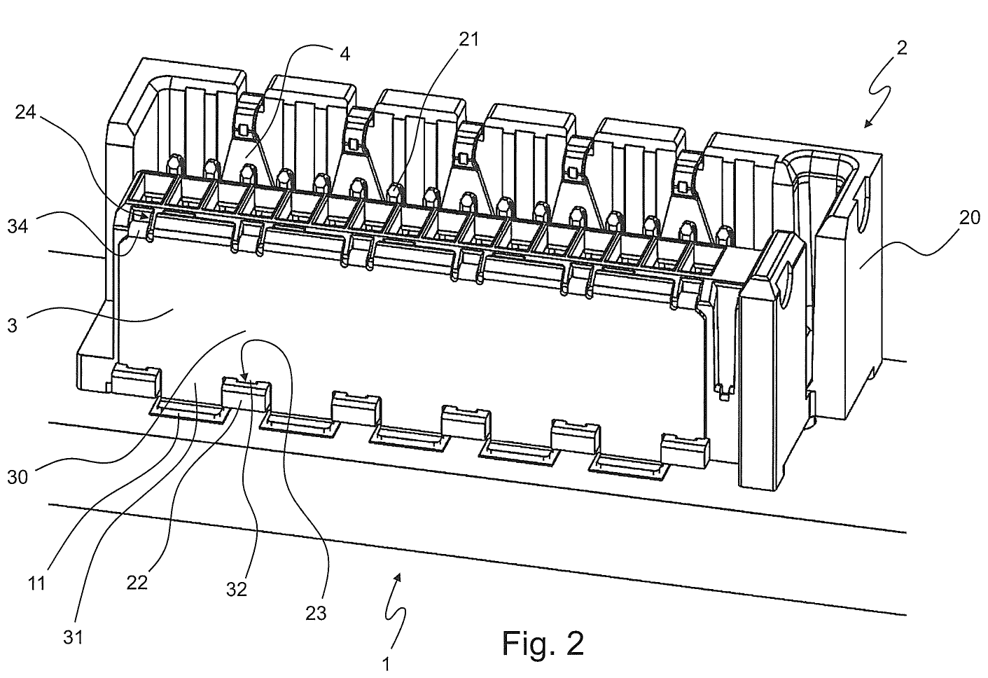

FIGS. 2 to 8 show a first embodiment of the plug connector 2 according to the invention, which is configured as a straight, non-angled plug connector 2. The plug connector 2 is mounted on the printed circuit board 1 and has a plug connector housing 20 and a plurality of contact elements 21. In the straight plug connector 2 according to the first embodiment, the contact elements 21 are mounted vertically on the printed circuit board 1 and extend linearly away from the printed circuit board 1. In the mounted state, the contact elements 21 are soldered to the first solder points 10 on the printed circuit board 1 and electrically contacted. The plug connector housing 20 is made of plastic and is manufactured using an injection molding process. The same plug connector housing 20 is used for the following variants.

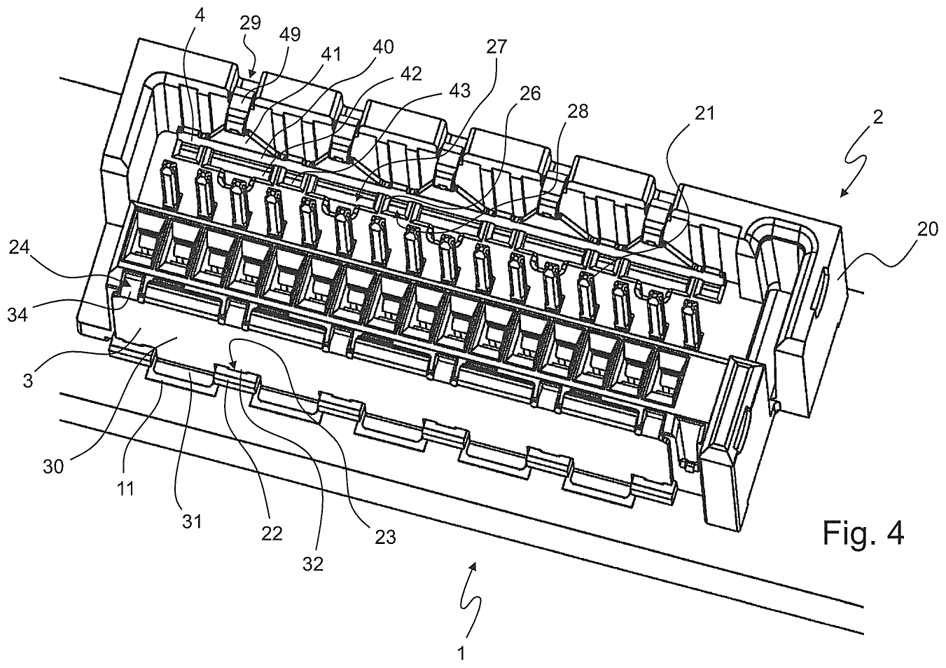

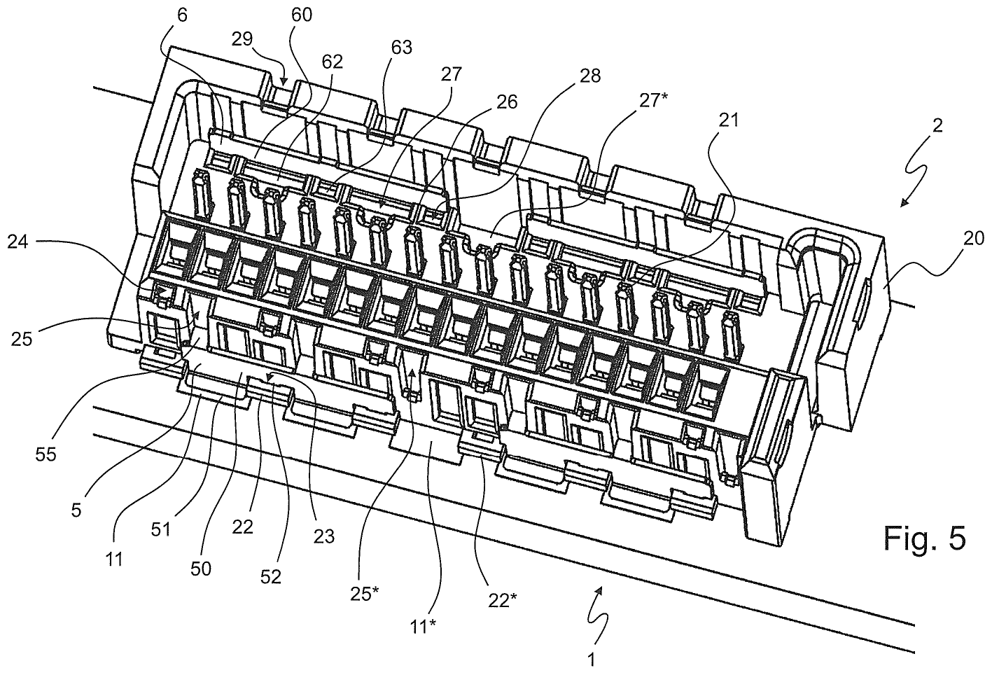

FIGS. 2 and 4 each show a shielded plug connector 2 according to a first embodiment with a front, first shielding plate 3 and a rear, second shielding plate 4 viewed from different perspectives. FIG. 5 shows a section through the rear area of the shielded plug connector 2.

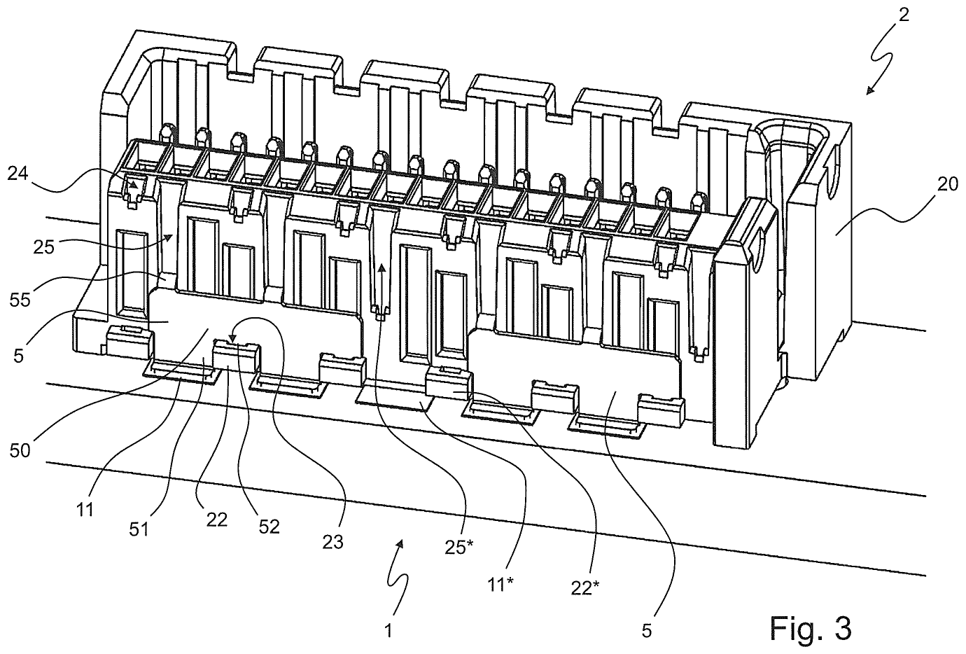

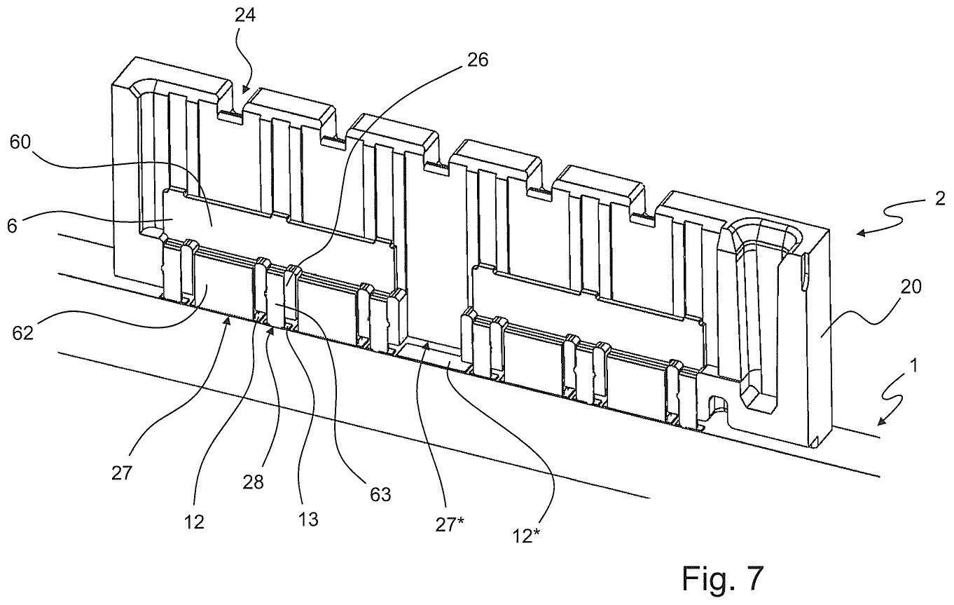

The shielding plates 3, 4 are made of a metal or a metal alloy, such as sheet copper, and have a metal coating suitable for electrical contacts, such as palladium, in the contact area. In the soldering area and in the area of the fastening elements (see below), the shielding plates 3, 4 may have a tin coating. FIGS. 3 and 5 each show an unshielded plug connector 2 with a front, first retaining plate 5 instead of the first shielding plate 3 and a rear, second retaining plate 6 instead of the second shielding plate 4 viewed from different perspectives. FIG. 7 shows a section through the rear area of the unshielded plug connector 2. The retaining plates 5, 6 are made of a metal or a metal alloy, such as sheet copper, and preferably have a tin coating.

In the following, the fastening of the first shielding plate 3 and the first retaining plate 5 to the front of the plug connector housing 20 is described in connection with FIGS. 2 and 3.

In FIG. 2, the first shielding plate 3 is arranged on the front outside of the plug connector housing 20 and extends essentially over the entire height and almost over the entire width (at least insofar as the contact elements 21 are arranged behind it) of the side surface. The first shielding plate 3 has a base section 30. In addition, the first shielding plate 3 has a plurality of solder feet 31 on the underside facing the printed circuit board 1, each of which is soldered to the second solder points 11 on the printed circuit board 1. In this way, on the one hand, electrical contact is made between the first shielding plate 3 and the printed circuit board 1 and, on the other hand, fastening of the first shielding plate 3 to the printed circuit board 1 is achieved.

The plug connector housing 20, as shown in FIG. 2, has a plurality of fastening bases 22 on the front side of the printed circuit board 1, each of which has an opening 23. The fastening base 22 with the opening 23 may be referred to as a fastening element or a first fastening element herein. The first shielding plate 3 has elongated shaped portions 32 between the solder feet 31, which engage in the openings 23 of the fastening bases 22. The elongated portions 32 may have fastening elements that engage complementary fastening elements in the openings 23. This realizes a first fastening of the first shielding plate 3 to the plug connector housing 20. In this embodiment, the elongated portions 32 are shortened such that they do not extend to the printed circuit board 1.

In other embodiments, the elongated portions 32 can extend to the printed circuit board 1 and be soldered there at solder points provided for this purpose. Hook-shaped fastening elements 34 are formed on the upper side of the first shielding plate 3, which grip around and engage in fastening openings 24 provided for this purpose on the upper edge of the plug connector housing 20. The fastening openings 24 can be referred to as third fastening elements herein. This provides further fastening of the first shielding plate 3 to the plug connector housing 20. In summary, the plug connector housing 20 is fastened to the printed circuit board 1 via the first shielding plate 3, which is soldered to the second solder points 11.

The third fastening element is arranged on the plug side of the plug connector housing 20. “Plug side” here refers to the direction opposite the printed circuit board 1 from which a mating plug connector is inserted. In the shielded variant, a complementary fastening element of the shielding plate 3 can engage in the at least one third fastening element. Since the shielding plate 3 typically extends over the entire height of the plug connector housing 20, the at least one third fastening element is arranged on the plug-side edge of the plug connector housing 20. The at least one third fastening element thus provides a further fastening point for the shielding plate 3.

The first retaining plate 5 shown in FIG. 3 is arranged on the front outside of the plug connector housing 20 instead of the first shielding plate 3 and has a significantly lower height compared to the first shielding plate 3. In this embodiment, the height of the first retaining plate 5 is approximately one third of the height of the plug connector housing 20. In addition, the retaining plate 5 in this embodiment does not extend continuously over the entire width of the plug connector housing 20, but rather two first retaining plates 5 are provided, between which there is a gap. Each first retaining plate 5 has a base section 50. In addition, the first retaining plate 5 also has several solder feet 51 on the underside, each of which is soldered to the same second solder points 11 on the printed circuit board 1.

The retaining plate 5 is connectable to the plug connector housing 20 without the shielding plate 3; the retaining plate 5 is used interchangeably with the shielding plate 3. Due to the reduced height of the retaining plate 5, shielding is not possible with the retaining plate 5. However, the surface area of the retaining plate 5 is smaller compared to the shielding plate 3, so that less material is required for the retaining plate 5, which results in material cost savings with the unshielded variant.

As shown in FIG. 3, not all solder points are used and, for example, the solder point 11* below the gap remains free. By soldering the solder feet 51 to the second solder points 11, a fastening of the first retaining plate 5 to the printed circuit board 1 is achieved, wherein the same second solder points 11 are used as described and thus the same arrangement of solder points can be used. Since the first retaining plate 5 has no shielding effect, the electrical contacting of the second solder points 11 is not of concern. The first retaining plate 5 has elongated portions 52 between the solder feet 51, which engage in the openings 23 of the same, aforementioned fastening bases 22 of the plug connector housing 20. Both variants of the plug connector 2 can be fastened with the same fastening element 20, 23. The elongated portions 52 may also have corresponding fastening elements. This results in a first fastening of the first retaining plate 5 to the plug connector housing 20 via the same fastening bases 22.

As shown in FIG. 3, a fastening base 22* located within the gap between the two first retaining plates 5 may be omitted. In this embodiment, the elongated portions 32 are also shortened. In other embodiments, they may extend to the printed circuit board 1 and be soldered there at solder points provided for this purpose. Claw-shaped fastening elements 55 are formed on the upper side of the first retaining plate 5, which engage in fastening grooves 25 provided for this purpose. The fastening grooves 25 may also be referred to herein as a fourth fastening element. The fastening grooves 25 extend from the upper edge of the plug connector housing 20 to the corresponding height of the first retaining plate 5. Here too, a fastening groove 25*, which is located within the gap between the two first retaining plates 5, can be omitted. By engaging the claw-shaped fastening element 55 in the fastening groove 25, further fastening of the first retaining plate 5 to the plug connector housing 20 is provided. In summary, the plug connector housing 20 is connected to the printed circuit board 1 via the first retaining plate 5, which is soldered to the same second solder points 11.

The height at which the fourth fastening element 25 is arranged is dependent on the height of the retaining plate 5. Since the retaining plate 5 has a height that is less than the height of the plug connector housing 20, the at least one fourth fastening element 25 is arranged essentially centrally on the side surface of the plug connector housing 20 and, when using the above-mentioned fastening elements, in particular between the third fastening element and the first fastening element or the second fastening element. The fourth fastening element thus provides a further fastening point for the retaining plate 5.

The fastening openings 24 and the fastening grooves 25 are arranged offset to one another both in height and in width. Thus, the first retaining plate 5 with its claw-shaped fastening elements 55 can be inserted precisely into the fastening grooves 25 without the risk of it engaging incorrectly in the fastening openings 24. The offset arrangement also means that no undercut is required in the plug connector housing 20, which simplifies manufacture. The fastening openings 24 and the fastening grooves 25 are at the same distance from each other. This prevents one of the fastening grooves 25 and one of the fastening openings 24 from coinciding and being arranged one below the other, even with wide plug connectors 2.

In further embodiments, a fastening extension can be provided on the front side of the plug connector housing 20 instead of the fastening opening on the upper edge of the plug connector housing 20 and/or instead of the fastening groove of the plug connector housing 20. The at least one third fastening element and/or the at least one fourth fastening element can also be the fastening extension projecting from an arrangement surface. The fastening element on the shielding plate 3 and/or the fastening element on the retaining plate 5 can then be configured as an extension receptacle, which has a receiving contour directed inwards into the extension receptacle, which has a clamping portion that rests on a fastening surface of the fastening extension after fastening. A so-called keyhole fastening can therefore be provided.

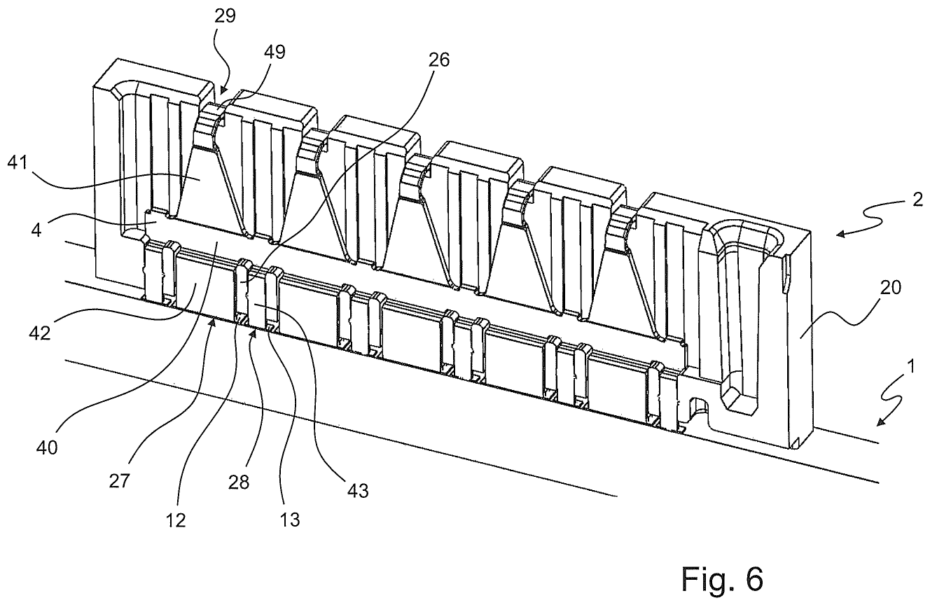

Fastening of the second shielding plate 4 and the second retaining plate 6 is described in connection with FIGS. 4 to 7. FIGS. 6 and 7 each show a sectional view of the plug connector 2 with the second shielding plate 4 and with the second retaining plate 6.

In FIGS. 4 and 6, the second shielding plate 4 is arranged on the rear inner side of the plug connector housing 20 and has a base section 40 and a plurality of triangular sections 41 extending upwardly from the base section 40. The base section 40 is seated downwardly on a fastening shoulder 26 of the plug connector housing 20 and is curved according to the shape of the fastening shoulder 26. In addition, the second shielding plate 4 has a plurality of solder feet 42, which are arranged on the curved section of the base section 40 and extend downwards through a first opening 27 of the fastening shoulder 26. The solder feet 42 are each soldered to the third solder points 12 of the printed circuit board 1. This ensures, on the one hand, that the second shielding plate 4 makes electrical contact with the printed circuit board 1 and, on the other hand, that the second shielding plate 4 is fastened to the printed circuit board 1 and to the plug connector housing 20.

In addition, the second shielding plate 4 has elongated portions 43 between the solder feet 42, as shown in FIG. 4, which engage in second openings 28 of the fastening shoulder 26. The second openings 28 of the fastening shoulder 26 may be referred to as a second fastening element herein. This results in further fastening of the second shielding plate 4 to the plug connector housing 20. In this embodiment, the elongated portions 43 extend through the second opening 28 and are soldered to fourth solder points 13 on the printed circuit board 1. In further embodiments, the elongated portions 43 may not be provided or may be shortened, so that they are fastened only via the solder feet 42. Hook-shaped fastening elements 49 are provided at the tip of the triangular sections 41, which grip around and engage in fastening recesses 29 at the rear upper edge of the plug connector housing 20 and abut against a web there. This provides further fastening of the second shielding plate 4 to the connector housing 20.

The second retaining plate 6 shown in FIGS. 5 and 7 is arranged on the rear inner side of the plug connector housing 20 instead of the second shielding plate 4 and has a significantly lower height compared to the second shielding plate 4. In this embodiment, the height of the second retaining plate 6 is approximately one third of the height of the plug connector housing 20. In addition, the second retaining plate 6 does not extend continuously over the entire width of the plug connector housing 20, but in this example two second retaining plates 6 are provided, between which there is a gap. Each second retaining plate 6 has a base section 60. The base section 60 is seated downwardly on the fastening shoulder 26 of the plug connector housing 20 and is curved to correspond to the fastening shoulder 26. In addition, the second retaining plate 6 has several solder feet 62 arranged on the curved section of the base section 60 and extending downwardly through a first opening 27 of the fastening shoulder 26. The solder feet 62 are soldered to the same third solder points 12 of the printed circuit board 1.

As shown in FIG. 7, not all openings and solder points are used and, for example, the opening 27* in the gap and the solder point 12* below the gap remain free. By soldering the solder feet 62 to the third solder points 13, fastening of the second retaining plate 6 to the printed circuit board 1 is achieved, wherein, as described, the same third solder points 12 are used and thus the same arrangement of solder points can be used. In addition, fastening of the second retaining plate 6 to the plug connector housing 20 is thus achieved. Since the second retaining plate 6 has no shielding effect, the electrical contacting of the third solder points 12 is of no concern. The second retaining plate 6 has elongated portions 63 between the solder feet 62, which engage the same second openings 28 of the fastening shoulder 26 and are soldered to the same fourth solder points 13. Both variants of the plug connector 2 can be connected to the same fastening element 26, 28. This provides further fastening of the second retaining plate 6 to the plug connector housing 20 via the same fastening shoulder 26. In further embodiments, the elongated portions 43 may not be provided or may be shortened so that fastening is provided only via the solder feet 62.

The fastening element of the shielding plate 4 or the retaining plate 6, in an embodiment, is not larger than the opening over its entire length in at least one spatial direction. The fastening element of the shielding plate 4 or the retaining plate 6 is held on the fastening shoulder 26 by a form fit and frictional connection.

In order to achieve fastening of the shielding plate 3, 4 or the retaining plate 5, 6, it is sufficient to insert the section of the shielding plate 3, 4 and/or the section of the retaining plate 5, 6 into the at least one first fastening element or into the at least one second fastening element. In doing so, the section of the shielding plate 3, 4 or the retaining plate 5, 6 can be severed, cut off, shortened or the like by simple methods. Alternatively, the section of the shielding plate 3, 4 and/or the section of the retaining plate 5, 6 can be passed through the at least one first fastening element or through the at least one second fastening element and soldered to the printed circuit board 1 at solder points provided for this purpose. This leads to a better retention and, in the case of the shielding plate 3, 4, to better contact with the printed circuit board 1. Advantageously, the same solder points are used for both variants.

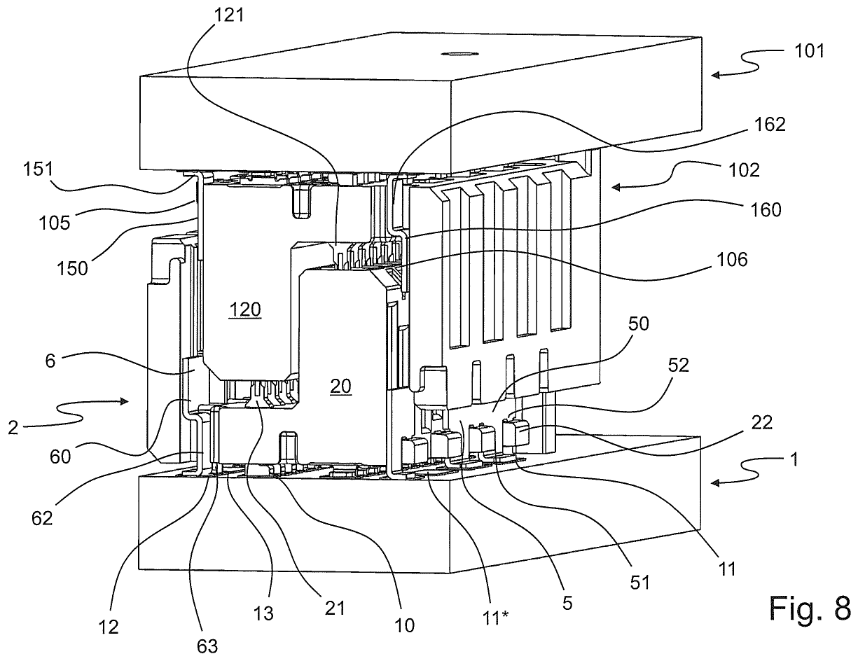

FIG. 8 shows the plug connector 2 and a mating plug connector 102, which are plugged into each other. This connects two printed circuit boards 1, 101 together. The plug connector 2 and the mating plug connector 102 are configured in the same way and can each be plugged into itself. The plug connector housing 20 of the plug connector 2 and a housing 120 of the mating plug connector 102 are adapted to each other in such a way that they can be plugged into each other and the contact elements 21 of the plug connector 2 are received and contacted in the mating plug connector 102 and contact elements 121 of the mating plug connector 102 are received and contacted in the plug connector 2. The plug connector 2 is connected to the printed circuit board 1 via the retaining plates 5, 6 as described above. The mating plug connector 102 is analogously connected to another printed circuit board 101 via retaining plates 105, 106.

In analogy to the above description, a first retaining plate 105 has a base section 150 and solder feet 151 connected thereto, as shown in FIG. 8, with which the first retaining plate 105 is soldered to solder points of the printed circuit board 101, which are provided for contacting a shielding plate for the mating plug connector 102. Similarly, a second retaining plate 106 has a base section 160, which is curved to fit a fastening shoulder, and solder feet 162 connected thereto, with which the second retaining plate 106 is soldered to further solder points of the printed circuit board 101 not shown, which are also provided for contacting a shielding plate for the mating plug connector 102.

In this process, the same solder points are used for fastening a shielded plug connector 2 by the shielding plate 3, 4 and for fastening an unshielded plug connector to the printed circuit board 1 by the retaining plate 5, 6. This makes it possible to manufacture a plug connector housing 20 with a fastening mechanism for both variants of the plug connector, that is, for the shielded plug connector and for the unshielded plug connector. The fastening elements described herein are all examples of the fastening mechanism of the plug connector housing 20.

The plug connector housing 20 can be manufactured in a simple manner in the same manufacturing process in one injection mold and then used for both variants-shielded plug connector or unshielded plug connector. In addition, the printed circuit board 1 can have the same arrangement (layout) of solder points for both variants. This offers the advantage that it is only necessary to decide which variant is to be used when the plug connector 2 is mounted on the printed circuit board 1. This considerably simplifies the configuration for the end customer. Another advantage is that one variant of the plug connector 2 can be replaced by the other variant without having to use a different printed circuit board 1.

A lower height of the retaining plate 3, 4 results in lower material costs, so that the lowest possible height is aimed for. However, there is a minimum height below which a secure retention can no longer be guaranteed. The minimum height depends on the specifications of the plug connector 2. A range for the height of the retaining plate is between half the height of the plug connector housing 20 and a quarter of the height of the plug connector housing 20. Material costs are effectively saved in this range, while at the same time the retention forces are still high enough. Material costs can also be reduced by dispensing with a precious metal layer for the retaining plate 3, 4, which is common for shielding plates.

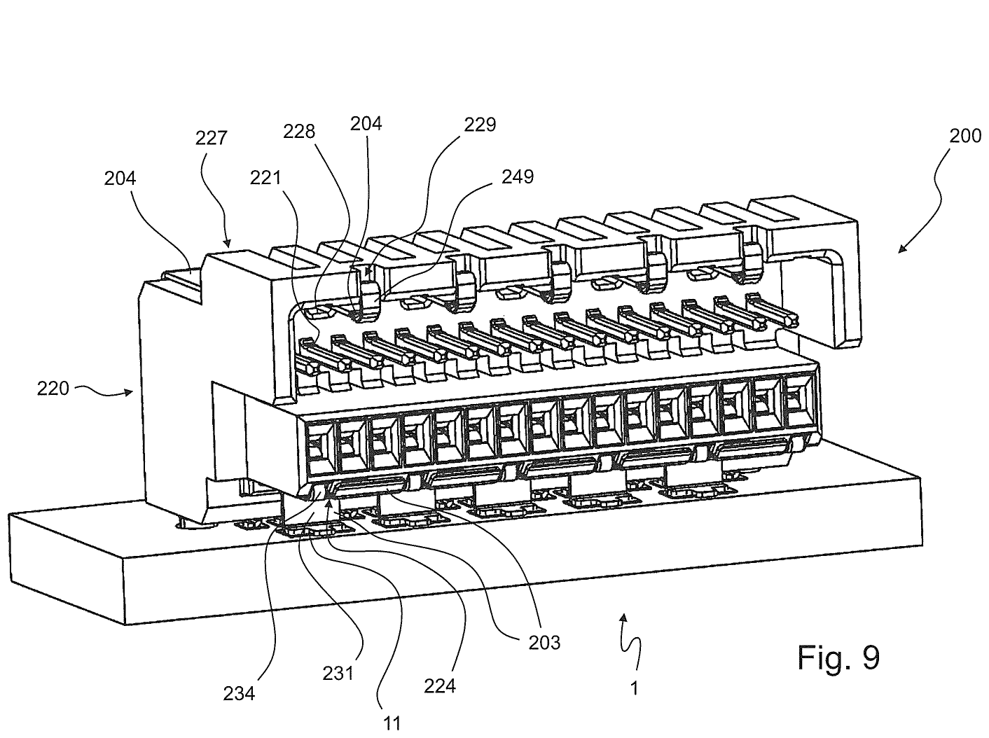

FIGS. 9 to 12 show a second embodiment of the plug connector 200 according to the invention, which is configured as an angled plug connector 200. In this embodiment, the plug connector 200 is angled at a 90° angle. The plug connector 200 is mounted on the printed circuit board 1 and has a plug connector housing 220 and contact elements 221. In the angled plug connector 200 according to the second embodiment, the contact elements 221 are mounted vertically on the printed circuit board 1 and are angled at a predeterminable height. In the mounted state, the contact elements 221 are soldered to the first solder points 10 on the printed circuit board 1 and electrically contacted. The plug connector housing 220 is made of plastic and is manufactured by an injection molding process. In the second embodiment, the plug connector housing 220 is angled accordingly. A further plug connector can then be plugged into the plug connector 200 from the side, parallel to the printed circuit board. The same plug connector housing 220 is used for the following variants.

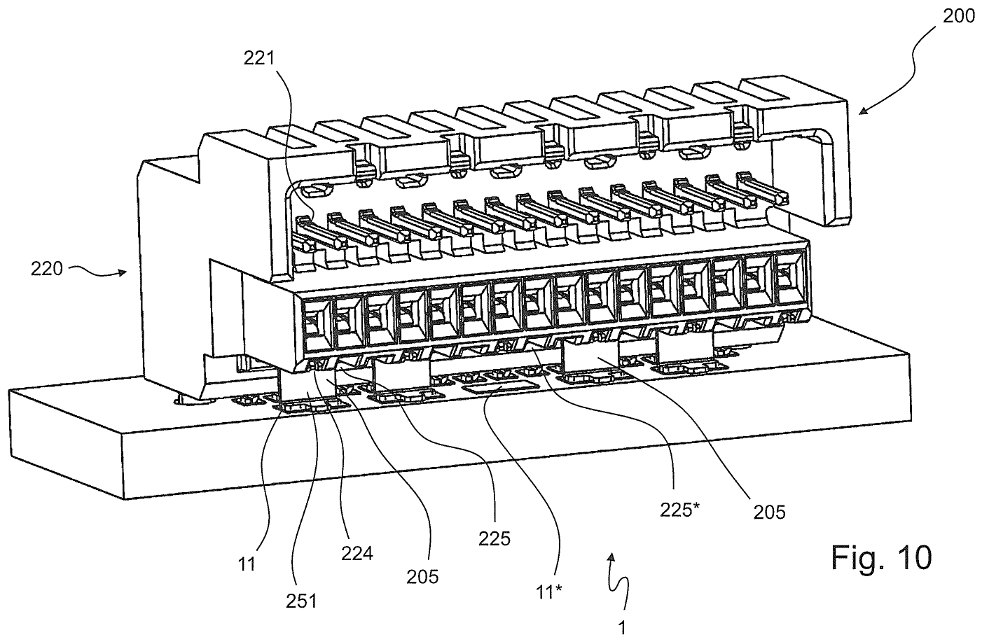

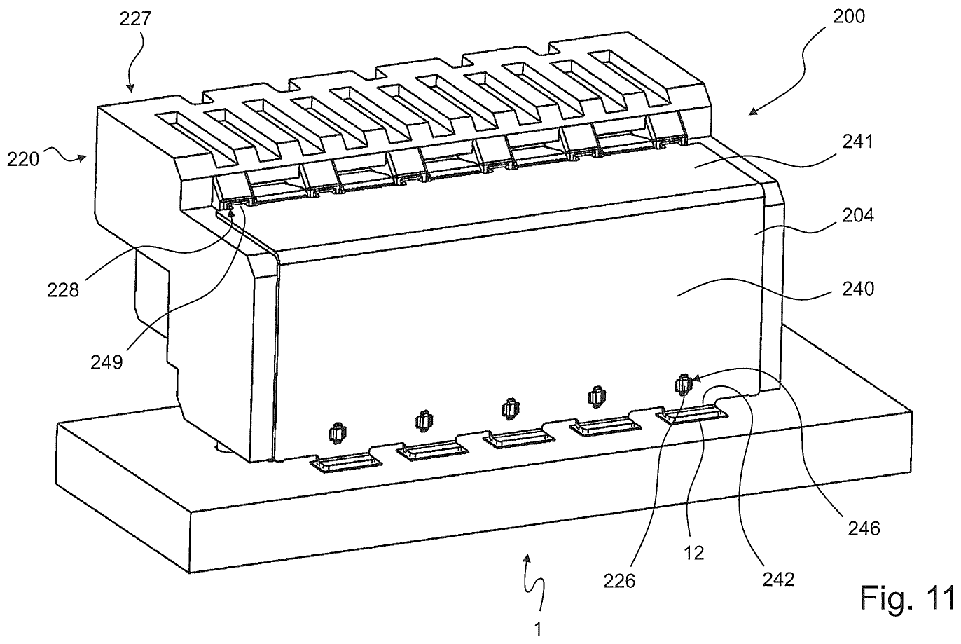

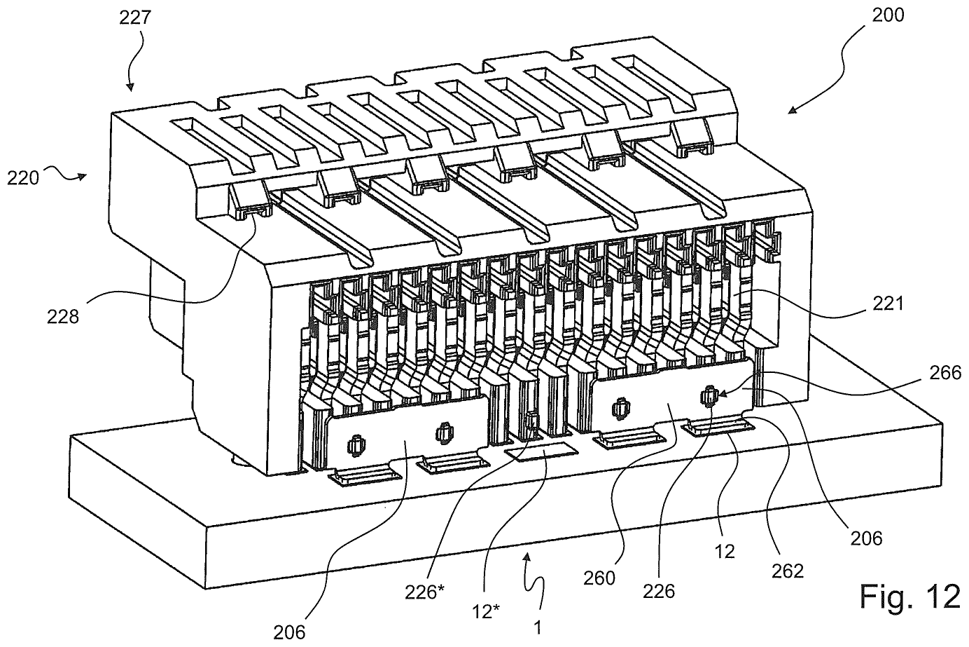

FIGS. 9 and 11 each show a shielded plug connector 200 according to the second embodiment with a lower, angled third shielding plate 203 and a rear and upper, angled fourth shielding plate 204 viewed from different perspectives. The shielding plates 203, 204 are made of a metal or a metal alloy, such as sheet copper, and have a metal coating suitable for electrical contacts, such as palladium, in the contact area. In the soldering area and in the area of the fastening elements (see below), the shielding plates 203, 204 preferably have a tin coating. FIGS. 10 and 12 each show an unshielded plug connector 200 with a lower, angled third retaining plate 205 instead of the third shielding plate 203 and a rear, fourth retaining plate 206 instead of the fourth shielding plate 204 viewed from different perspectives. The retaining plates 205, 206 are made of a metal or a metal alloy, such as sheet copper, and preferably have a tin coating.

Hereinafter, fastening of the third shielding plate 203 and the third retaining plate 205 to the front side and the underside of the plug connector housing 220 will be described in connection with FIGS. 9 and 10.

In FIG. 9, the third shielding plate 203 is angled and arranged at the lower and at the front outside of the plug connector housing 220. The third shielding plate 203 has a base section that is arranged at the underside of the plug connector housing 220 and cannot be seen. The base section of the third shielding plate 203 extends essentially over the entire depth and almost over the entire width (at least insofar as the contact elements 21 are arranged behind it) of the underside of the plug connector housing 220. In addition, the third shielding plate 203 has a plurality of solder feet 231 which are angled downwards from the base section on the rear side and extend along the lower front side of the plug connector housing 220. The solder feet 231 are each soldered to the second solder points 11 on the printed circuit board 1. This achieves, on the one hand, electrical contacting of the third shielding plate 203 with the printed circuit board 1 and, on the other hand, fastening of the third shielding plate 203 to the printed circuit board 1.

In embodiments, as described in the first embodiment and shown in FIG. 2, the third shielding plate 203 may be fastened to the plug connector housing 220 by an elongated portion through a fastening base having an opening. Hook-shaped fastening elements 234 are formed on the upper front side of the base section of the third shielding plate 203, which grip around and engage in fastening openings 224 provided for this purpose on the front edge of the plug connector housing 220. This provides fastening of the third shielding plate 203 to the plug connector housing 220. In summary, the plug connector housing 220 is fastened to the printed circuit board 1 via the third shielding plate 203, which is soldered to the second solder points 11.

In FIG. 10, the third retaining plate 205 is arranged at the lower and at the front outside of the plug connector housing 220 instead of the third shielding plate 203. Each third retaining plate 205 has a base section that is arranged on the underside of the plug connector housing 220 and cannot be seen. The base section of the third retaining plate 205 does not extend over the entire underside and covers one third of the depth of the underside in this embodiment. In addition, the retaining plate 205 in this embodiment does not extend continuously over the entire width of the plug connector housing 20, but two third retaining plates 205 are provided, between which there is a gap. In addition, each third retaining plate 205 has several solder feet 251 which are angled downwards from the base section on the rear side and extend along the lower front side of the plug connector housing 220. The solder feet 231 are each soldered to the same second solder points 11 on the printed circuit board 1.

As shown in FIG. 10, not all solder points are used and, for example, the solder point 11* below the gap remains free. By soldering the solder feet 251 to the second solder points 11, fastening of the third retaining plate 205 to the printed circuit board 1 is achieved, wherein the same second solder points 11 are used as described and thus the same arrangement of solder points can be used. Since the third retaining plate 205 has no shielding effect, the electrical contacting of the second solder points 11 is not of concern. The third retaining plate 205 may also have elongated portions that engage the openings of the same, aforementioned fastening bases of the plug connector housing 220, resulting in a fastening of the third retaining plate 205 to the plug connector housing 220 via the same fastening bases. Again, a fastening base located within the gap between the two third retaining plates 205 may be omitted. On the front side of the base section of the angled third retaining plate 205, claw-shaped fastening elements are formed which are not shown and engage in fastening grooves 225 provided for this purpose.

The fastening grooves 225, as shown in FIG. 10, extend on the underside of the plug connector housing 220 from its front edge to the corresponding depth of the third retaining plate 205. Here too, a fastening groove 225*, which is located within the gap between the two third retaining plates 205, can be omitted. By engaging the claw-shaped fastening element in the fastening groove 225, a further fastening of the first retaining plate 205 to the plug connector housing 220 is provided. In summary, the plug connector housing 20 is connected to the printed circuit board 1 via the third retaining plate 205, which is soldered to the same second solder points 11.

The fastening openings 224 and the fastening grooves 225 are arranged offset from one another both in height and in width. Thus, the third retaining plate 205 with its claw-shaped fastening elements can be inserted precisely into the fastening grooves 225 without the risk of incorrectly engaging the fastening openings 224. The offset arrangement also means that no undercut is required in the plug connector housing 220, which simplifies manufacture. The fastening openings 224 and the fastening grooves 225 have the same distance from each other. This prevents one of the fastening grooves 225 and one of the fastening openings 224 from coinciding and being arranged one below the other, even in the case of wide plug connectors 200.

In further embodiments, a fastening extension may be provided on the underside of the plug connector housing 220 instead of the fastening opening on the upper edge of the plug connector housing 220 and/or instead of the fastening groove of the plug connector housing 220. The fastening element on the shielding plate 203 and/or the fastening element on the retaining plate 205 can then be configured as an extension receptacle, which has a receiving contour directed inwards into the extension receptacle, which has a clamping portion that rests on a fastening surface of the fastening extension after fastening. A so-called keyhole fastening can therefore be provided.

Fastening of the fourth shielding plate 204 and the fourth retaining plate 206 to the rear side and to the upper side of the plug connector housing is described below in connection with FIGS. 11 and 12 and in connection with FIGS. 9 and 10.

In FIG. 11, the fourth shielding plate 204 is angled and arranged on the rear and upper outside of the plug connector housing 220. The fourth shielding plate 204 has a base section 240 arranged at the rear side of the plug connector housing 220, and an angled section 241 angled towards the base section 240 at the upper edge of the base section 240 and extending along the upper side of the plug connector. The base section 240 of the third shielding plate 204 extends essentially over the entire height and almost over the entire width (at least insofar as the contact elements 21 are arranged behind it) of the rear side. The angled section 241 of the third shielding plate 241 extends up to a raised section 227 of the plug connector housing 220 over the entire width (at least insofar as the contact elements 21 are arranged behind it) of the upper side. In addition, the fourth shielding plate 204 has several solder feet 242 arranged on the base section 240. The solder feet 242 are each soldered to the third solder points 12 of the printed circuit board 1. This achieves, on the one hand, an electrical contacting of the fourth shielding plate 204 with the printed circuit board 1 and, on the other hand, fastening of the fourth shielding plate 204 to the printed circuit board 1.

As shown in FIG. 11, the fourth shielding plate 204 has several openings 246 in the lower third of the surface of the base section 240. Pins 226 are arranged on the rear side of the plug connector housing 220, which protrude outwards and engage in the openings 246 of the fourth shielding plate 204. The pins 226 may be referred to herein as a fifth fastening element. This realizes a first fastening of the fourth shielding plate 204 to the plug connector housing 220. The angled section 241 has hook-shaped fastening elements 249, which are guided through openings 228 in the raised section 227 of the plug connector housing 220 and on the other side, as shown in FIG. 9, grip around and engage in fastening recesses 229 on the upper front edge of the plug connector housing 20 and abut against a web there. In this way, further fastening of the fourth shielding plate 204 to the plug connector housing 220 is achieved.

The fourth retaining plate 206 shown in FIG. 12 is arranged on the rear side of the plug connector housing 20 instead of the fourth shielding plate 204. When the fourth retaining plate 206 is used, the upper side of the plug connector 200 is only closed by the plug connector housing 220 but is not covered by a metal sheet. The fourth retaining plate 206 has a significantly lower height compared to the base section 240 of the fourth shielding plate 204. In this embodiment, the height of the fourth retaining plate 206 is approximately one third of the height of the plug connector housing 220 at the rear side. Furthermore, the fourth retaining plate 206 does not extend continuously over the entire width of the plug connector housing 220, but in this example two fourth retaining plates 206 are provided, between which there is a gap. Each fourth retaining plate 206 has a base section 260. In addition, the fourth retaining plate 206 has a plurality of solder feet 262 arranged on the base section 260. The solder feet 262 are each soldered to the third solder points 12 of the printed circuit board 1.

As shown in FIG. 12, not all solder points are used and, for example, the solder point 12* below the gap remains free. By soldering the solder feet 262 to the third solder points 13, fastening of the fourth retaining plate 206 to the printed circuit board 1 is achieved, wherein, as described, the same third solder points 12 are used and thus the same arrangement of solder points can be used. Since the fourth retaining plate 206 has no shielding effect, the electrical contacting of the third solder points 12 is not of concern. Further, the fourth retaining plate 206 also has several openings 266 formed in the surface of the base section 260 and arranged at the same locations as the openings 246 of the shielding plate 204 with respect to the solder feet 262. The pins 226 on the rear side of the plug connector housing thus also engage in the openings 266 of the fourth retaining plate 206. Here, as shown in FIG. 12, not all of the pins are used and, for example, the pin 226* in the gap remains free. In this way, fastening of the fourth retaining plate 206 to the plug connector housing 220 is realized. Each pin 226 as well as the corresponding opening 246 of the shielding plate 204 and the corresponding opening 266 of the retaining plate 206 are arranged in matching positions and can be positioned essentially freely.

The shielding plate 3, 4, 203, 204 serves not only for shielding but also for fastening the shielded plug connector 2 to the printed circuit board 1.

1. A plug connector, comprising:
a plug connector housing having a fastening mechanism; and
(a) a shielding plate connected to the fastening mechanism, the shielding plate is fastenable to a plurality of solder points of a printed circuit board and the plug connector is fastened to the printed circuit board by the shielding plate and the fastening mechanism; or
(b) a retaining plate connected to the fastening mechanism with the shielding plate omitted, the retaining plate has a height that is less than a height of the plug connector housing, the retaining plate is fastenable to the plurality of solder points of the printed circuit board and the plug connector is fastened to the printed circuit board by the retaining plate and the fastening mechanism.

2. The plug connector of claim 1, wherein the height of the retaining plate is less than half the height of the plug connector housing.

3. The plug connector of claim 2, wherein the height of the retaining plate is greater than a quarter of the height of the plug connector housing.

4. The plug connector of claim 1, wherein the fastening mechanism has a first fastening element and/or a second fastening element arranged on a printed circuit board side of the plug connector housing.

5. The plug connector of claim 4, wherein the shielding plate or the retaining plate engage in the first fastening element or the second fastening element.

6. The plug connector of claim 5, wherein the first fastening element is arranged on an outside of the plug connector housing and is a fastening base with an opening.

7. The plug connector of claim 6, wherein a fastening element of the shielding plate or a fastening element of the retaining plate engage the opening.

8. The plug connector of claim 5, wherein the second fastening element is arranged on an inside of the plug connector housing and is a fastening shoulder with an opening.

9. The plug connector of claim 8, wherein a fastening element of the shielding plate or a fastening element of the retaining plate engage the opening.

10. The plug connector of claim 9, wherein the fastening element of the shielding plate or the fastening element of the retaining plate is larger than the opening in at least one spatial direction and is held on the fastening shoulder by form fit and frictional engagement.

11. The plug connector of claim 5, wherein the shielding plate or the retaining plate pass through the first fastening element or through the second fastening element and is soldered to the plurality of solder points of the printed circuit board.

12. The plug connector of claim 4, wherein the fastening mechanism has a third fastening element on a plug side of the plug connector housing, the shielding plate engages in the third fastening element.

13. The plug connector of claim 12, wherein the fastening mechanism has a fourth fastening element on the plug connector housing engaging the retaining plate.

14. The plug connector of claim 13, wherein the third fastening element and/or the fourth fastening element is a fastening opening into which a hook-shaped fastening element engages.

15. The plug connector of claim 13, wherein the third fastening element and/or the fourth fastening element is a fastening groove into which a claw-shaped fastening element engages.

16. The plug connector of claim 13, wherein the third fastening element and the fourth fastening element are arranged offset with respect to one another.

17. The plug connector of claim 13, wherein the third fastening element is one of a plurality of third fastening elements on the plug connector housing and the fourth fastening element is one of a plurality of fourth fastening elements on the plug connector housing.

18. The plug connector of claim 17, wherein a distance between the third fastening elements corresponds to a distance between the fourth fastening elements.

19. The plug connector of claim 1, wherein the fastening mechanism has a fifth fastening element arranged on an outer surface of the plug connector housing.

20. The plug connector of claim 19, wherein the fifth fastening element is a pin inserted into an opening of the shielding plate or into an opening of the retaining plate.
